(19) United States
(12) Patent Application Publication
(10) Pub. No.: US 2019/0025889 A1
(43) Pub. Date: Jan. 24, 2019

(54) PIVOTALLY ENGAGEABLE MODULAR ELECTRONIC DEVICES AND METHODS OF OPERATION

(71) Applicant: NANOPORT TECHNOLOGY INC., Markham (CA)

(72) Inventor: Timothy Jing Yin SZETO, Mississauga (CA)

(21) Appl. No.: 16/069,931

(22) PCT Filed: Jan. 12, 2017
(86) PCT No.: PCT/CA2017/050040

§ 371 Date: Jul. 13, 2018

Related U.S. Application Data
(60) Provisional application No. 62/278,822, filed on Jan. 14, 2016.

(51) Int. Cl. G06F 1/16; G06F 3/0338; G06F 3/0346; G06F 3/03; G06F 3/14; G06F 3/0488

(52) U.S. Cl. CPC G06F 1/1677; G06F 1/1618; G06F 1/1681; G06F 3/0338; G06F 1/3246; G06F 3/0304; G06F 3/1446; G06F 3/04886; G06F 3/0346

(57) ABSTRACT

The modular electronic device is generally configured for coupling with at least one other modular electronic device of a modular electronic device system wherein the modular electronic devices of the modular electronic device system. Each modular electronic device has a housing with lateral edges having at least one magnetic coupler. Any two of the modular electronic devices are coupleable to one another by engaging corresponding magnetic couplers of the two modular electronic devices with one another, the coupled modular electronic devices being pivotable relative to one another. The modular electronic device further comprises a processor configured for receiving a measurement of the relative pivot angle between the modular electronic device and an other modular electronic device coupled thereto, and selecting a software function based on the measurement of the relative pivot angle.

### FIELD

This disclosure relates to modular electronic device systems and more particularly to modular electronic devices which are coupleable to one another using magnetic couplers.

### BACKGROUND

A Nanoport™ magnetic coupler allows a user to combine two or more electronic devices like magnetic building blocks, allowing users to create coupled modular electronic devices such as foldable tablets, modular phones, etc., by snapping together hardware. During use, the coupled modular electronic devices are pivotable relative to each other so that they can be used in one of many applications.

Although existing modular electronic device systems are satisfactory to a certain degree, there remains room for improvement. For instance, as in all electronic equipment, an important factor of success is the intuitiveness with which functions can be activated by the user via the user interface. Modular electronic devices open a field of new possibilities.

### SUMMARY

In accordance with one aspect, it was found that by monitoring a relative pivot angle between any two coupled modular electronic devices using at least one pivot angle sensor included inside the housing of at least one of the modular electronic devices, a processor of any one of the modular electronic devices can select some predetermined software functions on either or both of the modular electronic devices based on the monitored relative pivot angle.

In accordance with another aspect, there is provided a modular electronic device configured for coupling with at least one other modular electronic device of a modular electronic device system wherein the modular electronic devices of the modular electronic device system each have a housing with lateral edges having at least one magnetic coupler and wherein any two of the modular electronic devices are coupleable to one another by engaging corresponding magnetic couplers of the two modular electronic devices with one another, the coupled modular electronic devices being pivotable relative to one another, the modular electronic device comprising a processor configured for receiving a measurement of the relative pivot angle between the modular electronic device and another modular electronic device coupled thereto, and selecting a software function based on the measurement of the relative pivot angle.

In accordance with another aspect, there is provided a method of operating a modular electronic device system comprising a modular electronic device coupled to at least one other modular electronic device, the modular electronic devices each having a housing with lateral edges having at least one magnetic coupler, any two of the modular electronic devices being coupleable to one another by engaging corresponding magnetic couplers of the two modular electronic devices with one another, the coupled modular electronic devices being pivotable relative to one another, the method comprising: receiving, using a processor included in the housing of the modular electronic device, a measurement of the relative pivot angle between the modular electronic device and the other modular electronic device coupled thereto; and selecting a software function based on the measurement of the relative pivot angle.

Many further features and combinations thereof concerning the present improvements will appear to those skilled in the art following a reading of the instant disclosure.

### DESCRIPTION OF THE FIGURES

In the figures,

FIG. 1 is an oblique view of an example of two modular electronic devices coupled to one another in an open configuration, with both front faces facing in a same direction, in accordance with an embodiment;

FIG. 1A is a bottom plan view of the two modular electronic devices of FIG. 1 taken along line 1A-1A of FIG. 1;

FIG. 2 is front elevation view of an example of two modular electronic devices with the front faces facing in different directions, in accordance with an embodiment;

FIG. 2A is a bottom plan view of the two modular electronic devices of FIG. 2 taken along line 2A-2A of FIG. 2;

FIG. 3 is an oblique view of an example of two modular electronic devices coupled to one another in a face-to-face configuration, in accordance with an embodiment;

FIG. 3A is a bottom plan view of the two modular electronic devices of FIG. 3 taken along line 3A-3A of FIG. 3;

FIG. 4 is an oblique view of an example of two modular electronic devices coupled to one another in a laptop configuration, in accordance with an embodiment;

FIG. 4A is a bottom plan view of the two modular electronic devices of FIG. 4 taken along line 4A-4A of FIG. 4;

FIG. 5 is an oblique view of an example of two modular electronic devices coupled to one another in a back-to-back configuration, in accordance with an embodiment;

FIG. 5A is a bottom plan view of the two modular electronic devices of FIG. 5 taken along line 5A-5A of FIG. 5;

FIG. 6 is a bottom plan view of an example of two modular electronic devices coupled to one another in a back-to-back configuration, wherein one of the modular electronic devices faces a user, in accordance with an embodiment;

FIG. 7 is a bottom plan view of an example of three modular electronic devices coupled to one another in a camera stand configuration, in accordance with an embodiment;

FIG. 8 is a cross-sectional view of an example of two modular electronic devices coupled to one another, showing an example of a pivot sensor integrated to a corresponding magnetic coupler of each modular electronic device, in accordance with an embodiment;

FIG. 9A is a schematic view of an example of exterior and interior strips of the pivot sensor of FIG. 8, in accordance with an embodiment; and

FIG. 9B is a schematic view of an example of a conductive trace associated with either one of the exterior or interior strip of FIG. 9A, in accordance with an embodiment.

### DETAILED DESCRIPTION

In a modular electronic device system, modular electronic devices are configured for being coupled with one another. Each modular electronic device has a housing with lateral edges having magnetic coupler(s). Any two of the modular electronic devices can be coupleable to one another by engaging corresponding magnetic couplers of the modular electronic devices with one another so that the coupled modular electronic devices are pivotable relative to one another.

In such a modular electronic device system, the configuration that will be formed by the modular electronic devices is unknown beforehand, and there are many more possibilities than in the existing multi-panel electronic devices. For instance, modular electronic devices can be flipped relative to one another and reattached, and the resulting modular electronic system can form a triangle in a camera stand configuration.

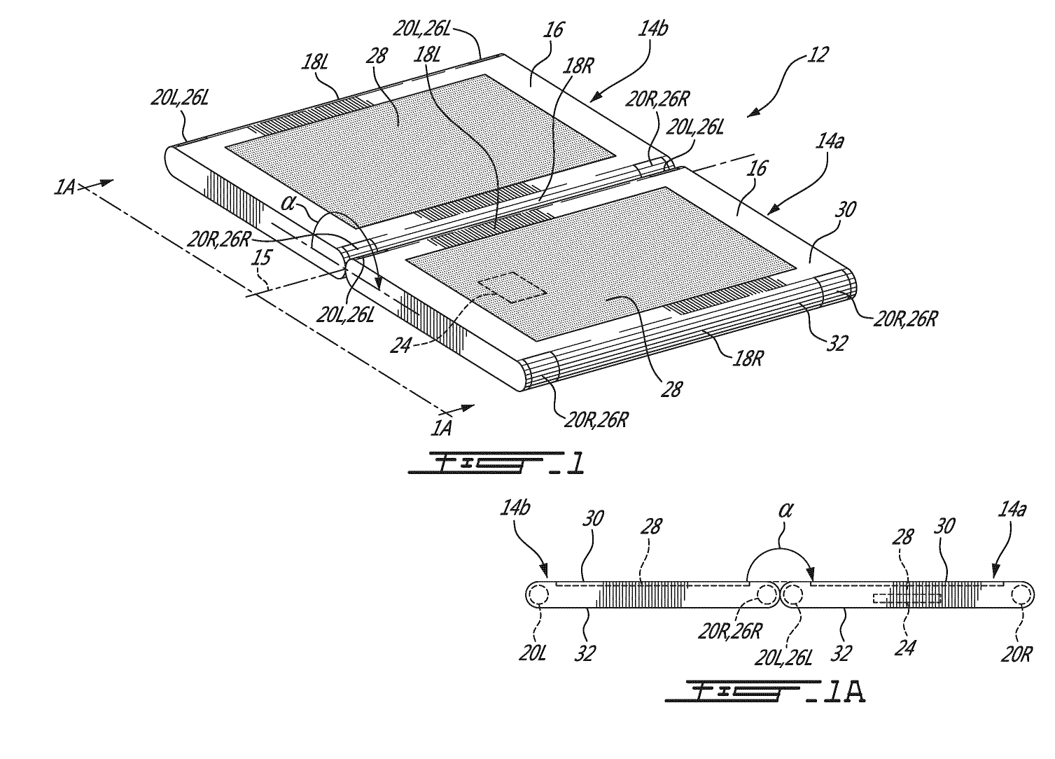

An example of a modular electronic device system 12 (referred to as “modular system 12”) is shown in FIG. 1. This specific example has modular electronic devices 14a and 14b coupled to one another. The modular electronic devices 14a and 14b can be any electronic device that interface with one another and provide complementary functions. For instance, the modular electronic devices 14a and 14b of the modular system 12 can be mobile electronic devices (e.g., mobile phones, tablet computers, laptop computers, or the like). In this specific example, the modular electronic devices 14a and 14b are provided in the form of smartphones. However, in other embodiments, one modular electronic device can be a smartphone and the other an accessory, such as a speaker or a storage device. As further examples, one of the devices can be a smartphone and the other a viewing screen, or both can be viewing screens, or one can be a screen and the other a keyboard; one device can be a touch screen enabled device and the other a router to communicate to the Internet, or one can be a camera and the other a smart phone to store images from the camera. These examples are non-limiting and it will be apparent that many mutually complementary devices exist that can benefit from interconnection and interoperation.

As shown, each modular electronic device 14a, 14b has a housing 16 having two lateral edges 18L and 18R and is equipped with two magnetic couplers at each corner of the two lateral edges 18L and 18R of the housing 16. For ease of reference, the magnetic couplers of the lateral edge 18L are referred to as magnetic couplers 20L and, similarly, the magnetic couplers of the lateral edge 18R are referred to as magnetic couplers 20R. The modular electronic devices 14a, 14b are said to be coupled to one another when corresponding magnetic couplers of the modular electronic devices 14a and 14b are engaged with one another. In this example, adjacent ones of the lateral edges of the modular electronic devices 14a and 14b are juxtaposed to one another such that the modular electronic devices 14a and 14b are arranged in a side-by-side configuration.

Examples of possible magnetic couplers 20L, 20R are described in international patent application publication no. WO 2015/070321 and U.S. Pat. No. 9,312,633, the contents of which are incorporated by reference herein. The magnetic couplers 20L, 20R can offer an optional electrical connection function in addition to its mechanical coupling function. Indeed, the modular electronic devices 14a and 14b of the modular system 12 can be electrically connectable to one another by mechanical coupling corresponding ones of the magnetic couplers 20L, 20R of the modular electronic devices 14a and 14b with one another. A USB 2.0/3.0 bus can be established through the electrical connection. This optional configuration can allow an electrical connection between the modular electronic devices 14a and 14b to be maintained while pivoting the modular electronic devices relative to one another. However, it will be understood that the modular electronic devices 14a and 14b can communicate data and/or power wirelessly with one another, in which case the magnetic couplers 20L, 20R need not establish an electrical connection.

During operation, one of the modular electronic devices 14a and 14b may function as a host and the other may function as a slave. In some embodiments, the host-slave roles may switch depending on function(s) being performed. Therefore, each of the modular electronic devices 14a and 14b can include a hub configured to allow the host-slaves roles to be dynamically assigned during operation, as described in U.S. patent application Ser. No. 14/988,296, the contents of which are incorporated by reference herein.

Alternate embodiments of modular systems, modular electronic device and magnetic couplers can exist or be developed.

The magnetic couplers 20L, 20R are rotatable around an axis 15 extending along the lateral edge 18R of the modular electronic device 14b (and equivalently along the lateral edge 18L of the modular electronic device 14a, and the lateral edges 18L and 18R are provided with a semi-circular shape acting as a projection of the shape of the magnetic couplers 20L, 20R. The magnetic couplers 20L, 20R thus form a hinge around which the modular electronic devices 14a and 14b can pivot relative to one another along their lateral edges when coupled, allowing smooth switching between the configurations shown in FIGS. 1, 3, 4 and 5, for instance, without interrupting the mechanical coupling and/or the electrical connection between the modular electronic devices 14a and 14b. As can be seen in FIGS. 1 and 1A, the modular electronic devices 14a and 14b are arranged in a side-by-side configuration with a relative pivot angle of 180° between the modular electronic devices 14a and 14b. In this example, the magnetic couplers 20L of the modular electronic device 14a are engaged with the magnetic couplers 20R of the modular electronic device 14b.

In this example, the modular electronic device 14a has a processor 24 included in the housing 16 and configured to receive a measurement of the relative pivot angle between the modular electronic device 14a and the other modular electronic device 14b when the modular electronic devices 14a and 14b are coupled to one another. The processor 24 is also configured to select a software function based on the measurement of the relative pivot angle.

For instance, the processor 24 can select a software function by selecting particular code to be executed at either one or both the modular electronic devices 14a and 14b. The particular code can cause launching or closing of a particular application. The particular code can also activate/deactivate software or hardware resources at either one or both the modular electronic devices 14a and 14b. For example, the processor 24 can select a software function which causes a camera of the modular electronic device 14a to be activated and, simultaneously, causes a camera application of the modular electronic device 14b to be activated. Other examples are described in fuller detail below.

Accordingly, the processor 24 can cause change in functioning modes of the modular electronic devices 14a and 14b based on their relative pivot angle. The change in functionality of the modular electronic devices 14a and 14b may promote efficient division of functionality between the modular electronic devices 14a and 14b based on the relative pivot angle or promote cooperative functionality between the modular electronic devices 14a and 14b.

The measurement of the relative pivot angle can be received from one or more pivot angle sensors integrated in the housing 16 of the modular electronic device 14a but it can also be received from one or more pivot sensors integrated in the housing 16 of the other modular electronic device 14b. For instance, in the embodiment illustrated in FIG. 1, pivot angle sensors 26L, 26R are integrated in corresponding ones of the magnetic couplers 20L, 20R of the housing 16 of the modular electronic devices 14a and 14b. In this embodiment, the pivot angle sensors 26L and 26R of coupled ones of the magnetic couplers 20L and 20R can communicate a respective one of four relative pivot angles to the processor 24. The processor 24 can thus select the software function based on one or more of the relative pivot angles received.

In some embodiments, the selection of the software function by the processor 24 causes particular code to be executed. In some other embodiments, the processor 24 transmits the selected software function to one or more of the other modular electronic devices of the modular system 12. In the case where the selected software function is transmitted to the modular electronic device 14b, the particular code associated to the selected software function can be executed by the modular electronic device 14b. In this case, the selection of the software function for both modular electronic devices 14a and 14b can be made by a modular electronic device in the host role, which as noted above, can change during operation.

As can be seen, in this example, the modular electronic devices 14a and 14b are both provided in the form of mobile phones with touch screens 28. More specifically, each touch screen 28 is provided in a front face 30 of the housing 16 of a corresponding one of the modular electronic devices 14a and 14b. Each touch screen 28 thus faces away from a back face 32 opposite to the front face 30 having the touch screen 28.

As best seen in the example shown in FIGS. 1 and 1A, the modular electronic devices 14a and 14b are coupled in a first coupling configuration wherein the magnetic couplers 20L of the modular electronic device 14a are engaged with the magnetic couplers 20R of the modular electronic device 14b. In this first coupling configuration, the relative pivot angle can be defined as a relative face-to-face pivot angle α between the front face 30 of the modular electronic device 14a and the front face 30 of the other modular electronic device 14b. In this embodiment, the front faces 30 of the modular electronic devices 14a and 14b can face in a same direction.

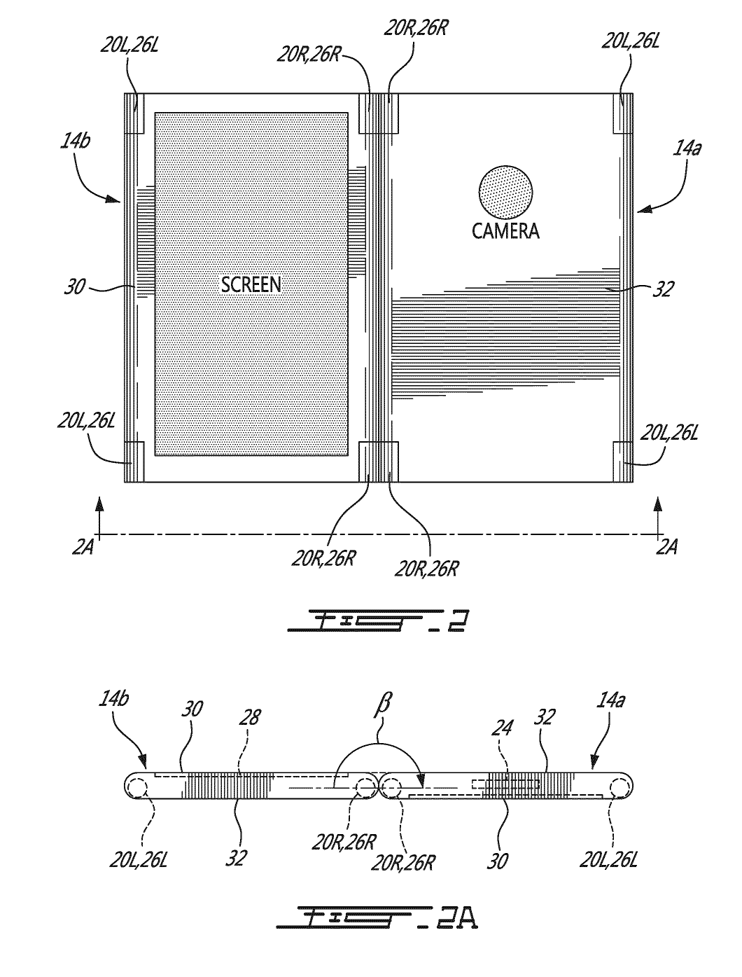

However, it will be understood that the modular electronic devices 14a and 14b can be coupled differently. For instance, as best seen in the example shown in FIGS. 2 and 2A, the modular electronic devices 14a and 14b are coupled in a second coupling configuration wherein the magnetic couplers 20R of the modular electronic device 14a engaged with the magnetic couplers 20R of the modular electronic device 14b. In this second coupling configuration, the relative pivot angle can be defined as a relative face-to-back pivot angle β between the front face 30 of the modular electronic device 14a and the back face 32 of the modular electronic device 14b. In this latter embodiment, the front faces 30 of the modular electronic devices 14a and 14b can face in opposite directions.

In either case, the processor 24 may be configured to disambiguate whether the modular electronic devices 14a and 14b are coupled to one another in the first coupling configuration or in the second coupling configuration.

For instance, in a first exemplary disambiguation method, the processor 24 can determine an orientation of each modular electronic device 14a,14b by reading a measurement received from a corresponding gyroscope sensor, which can provide a reading that varies according to whether the modular electronic device is facing up or facing down (or in between), relative to Earth's gravity. In this disambiguation method, one of the modular electronic devices 14a and 14b can determine its own face up/down state using its own sensor, and then query the other modular electronic device for that other modular electronic device's face up/down state.

In a second exemplary disambiguation method, the processor 24 can determined which of the magnetic couplers 20L or 20R of the modular electronic device 14a is engaged to which of the magnetic couplers 20L or 20R of the other modular electronic device 14b in order to distinguish if the relative pivot angle is a face-to-face pivot angle α or a face-to-back pivot angle β. Such a determination can be based on the fact that coupled couplers are activated while uncoupled couplers are not activated, and that the processor 24 can determine whether or not a magnetic coupler is activated according to the methods described in U.S. patent application Ser. No. 62/327826, the contents of which are incorporated herein. In this disambiguation method, the processor 24 can determine its own active magnetic couplers, and then query the other modular electronic device 14b for the other modular electronic device's active connectors.

The second exemplary disambiguation method also allows one of the modular electronic devices 14a and 14b to determine its position (e.g., left or right) relative to the other one of the modular electronic devices 14a and 14b. The software function selection may also take this into account. For example, the touch screens can be stitched such that the left side of an image is displayed on the touch screen of the modular electronic device positioned on the left side and the right side of the image is displayed on the touch screen of the modular electronic device positioned on the right side.

The first and second disambiguation methods described above can be used in combination for greater robustness.

The processor 24 can be configured to select a software function based on the measurement of the relative pivot angle α or β. More specifically, the processor 24 can be configured to select a software function when the processor 24 determines that the relative pivot angle α or β is within a given range of relative pivot angles.

Referring back to the embodiment shown in FIGS. 1 and 1A, the given range of relative pivot angles α is between 135° and 225°. In this case, the modular electronic devices 14a and 14b can be said to be arranged in a side-by-side configuration, and more specifically in an open configuration.

In this embodiment, the processor 24 receives a measurement of the relative face-to-face pivot angle α and selects a display function for the touch screen 28 of the modular electronic device 14a and a display function for the touch screen 28 of the other modular electronic device 14b such that the display functions of the touch screens 28 are stitched to one another. When touch screens are so stitched, displayed content may span both screens. It is understood that the measurement of the relative face-to-face pivot angle α can be received from one or both pivot angle sensors 20L of the modular electronic device 14a and/or from one or both pivot angle sensors 20R of the modular electronic device 14b. In some embodiments, an image or a video can be displayed across the touch screens 28 so as to provide a larger, higher resolution of what can be achieved with a single touch screen 28. In some other embodiments, the open configuration can provide an extended desktop wherein the modular electronic devices cooperatively render or display content using the touch screens 28 of both modular electronic devices 14a and 14b.

In the open configuration, it is noted that one of the modular electronic device 14a can function as a host and transmit a data signal including image data or video data to the other modular electronic device 14b functioning as a slave, or vice versa. The transmission of the data signal can be over a wireless connection or through a USB (or similar) connection established through the magnetic couplers 20L, 20R. The stitching of the touch screens 28 can be performed in a manner similar to that described in international patent application publication no. WO 2015/070321.

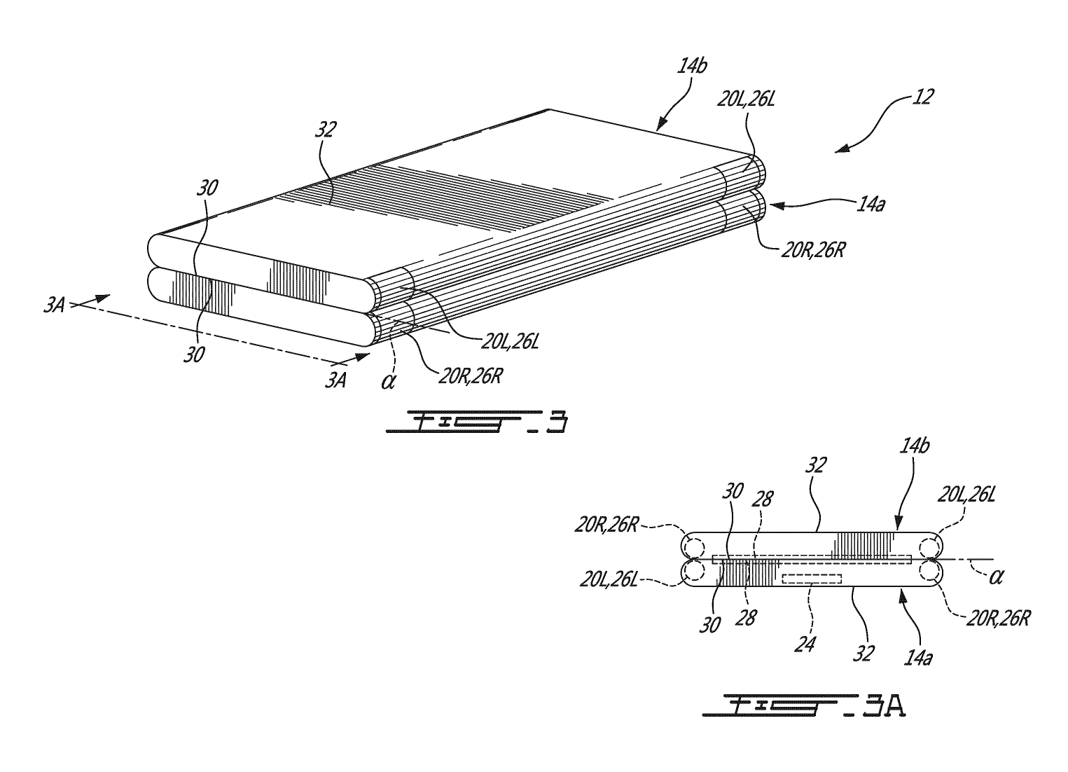

Referring now to FIGS. 3 and 3A, the given range of relative face-to-face pivot angles α is between 0° and 15°. In this case, the modular electronic devices 14a and 14b can be said to be arranged in a face-to-face configuration wherein the front face 30 of the modular electronic device 14a faces the front face 30 of the modular electronic device 14b. In other words, the modular electronic devices 14a and 14b are placed on top of one another, so that the front face 30 of the modular electronic device 14a abuts on the front face 30 of the modular electronic device 14b.

Accordingly, when the processor 24 determines that the relative face-to-face pivot angle α is approximately 0°, the processor 24 is configured to lock the touch screens 28 of the modular electronic devices 14a and 14b in some embodiments and, alternately or additionally, put the modular electronic devices 14a and 14b into a sleep mode in some other embodiments. It is noted that when the modular electronic devices 14a and 14b are in the face-to-face configuration, locking or turning off the touch screens 28 and/or putting the modular electronic devices 14a and 14b into a sleep mode can considerably reduce the power consumption of the modular system 12.

In this specific embodiment, the relative face-to-face pivot angle α can be received from any one of the pivot sensors 26L and 26R of both the modular electronic devices 14a and 14b.

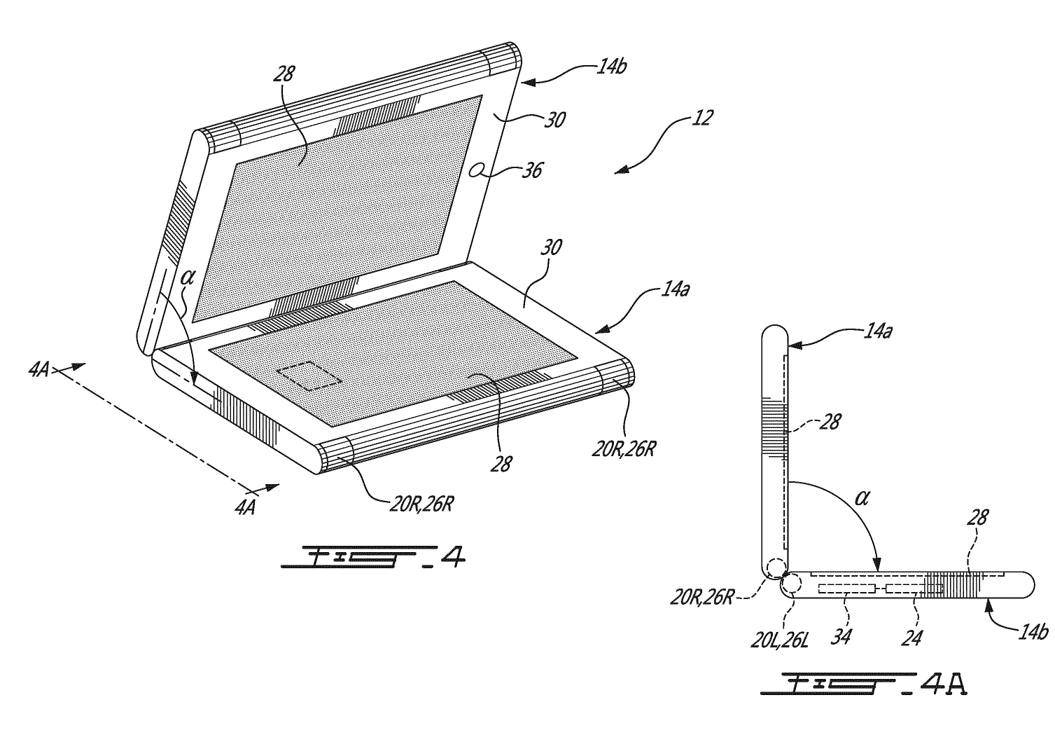

Reference is now made to FIGS. 4 and 4A, wherein the given range of relative face-to-face pivot angles α is between 75° and 135°. In this case, the modular electronic devices 14a and 14b can be said to be in an “laptop configuration” wherein the modular electronic devices 14a and 14b are relatively perpendicular to one another. In this embodiment, the processor 24 selects an on-screen keyboard function for the touch screen 28 of the modular electronic device 14a and selecting a display function for the touch screen 28 of the other modular electronic device 14b. Accordingly, the touch screen 28 of the modular electronic device 14a can be used as a keyboard for receiving one or more user inputs whereas the touch screen 28 of the other modular electronic device 14b can be used as a screen for viewing content.

Additional data can be received by the processor 24 in order to disambiguate between which software function, i.e. the on-screen keyboard function or the display function, will be selected for the each of the modular electronic devices 14a and 14b. Notwithstanding the manner how this disambiguation is performed, it is preferred that the touch screen 28 of one of the modular electronic devices which faces a user be used as a display.

For instance, in this embodiment, the processor 24 can determine which of the touch screens 28 will function as an on-screen keyboard or as a viewing screen based on a measurement of an orientation of either or both of the modular electronic devices 14a, 14b. For instance, in some embodiments, the processor 24 can receive a measurement of an orientation of the modular electronic device 14 indicating that the touch screen 28 of the modular electronic device 14a faces upwards and select, accordingly, the on-screen keyboard function for the modular electronic device 14a and the display function for the modular electronic device 14b. Such a measurement can be received from a gyroscope sensor 34 integrated to the housing 16 of the modular electronic device 14a, as shown in FIG. 4A. However, the gyroscope sensor 34 can also be integrated to the housing of the other modular electronic device 14b.

In some other embodiments, the processor 24 can receive an indication that the touch screen 28 of the modular electronic device 14b faces a user and select the on-screen keyboard function for the modular electronic device 14a and the display function for the modular electronic device 14b. In the latter embodiments, the indication can be received from a camera 36 provided at the front face 30 of the modular electronic device 14b, as shown in FIG. 4. In these embodiments, the indication is based on visual recognition, e.g., facial recognition.

In alternate embodiments, the processor 24 can be configured to select which one of the on-screen keyboard function and the display function will be selected based on one or more user inputs received from buttons(s) and/or a touch screen. Other embodiments of the gyroscope sensor can also be used.

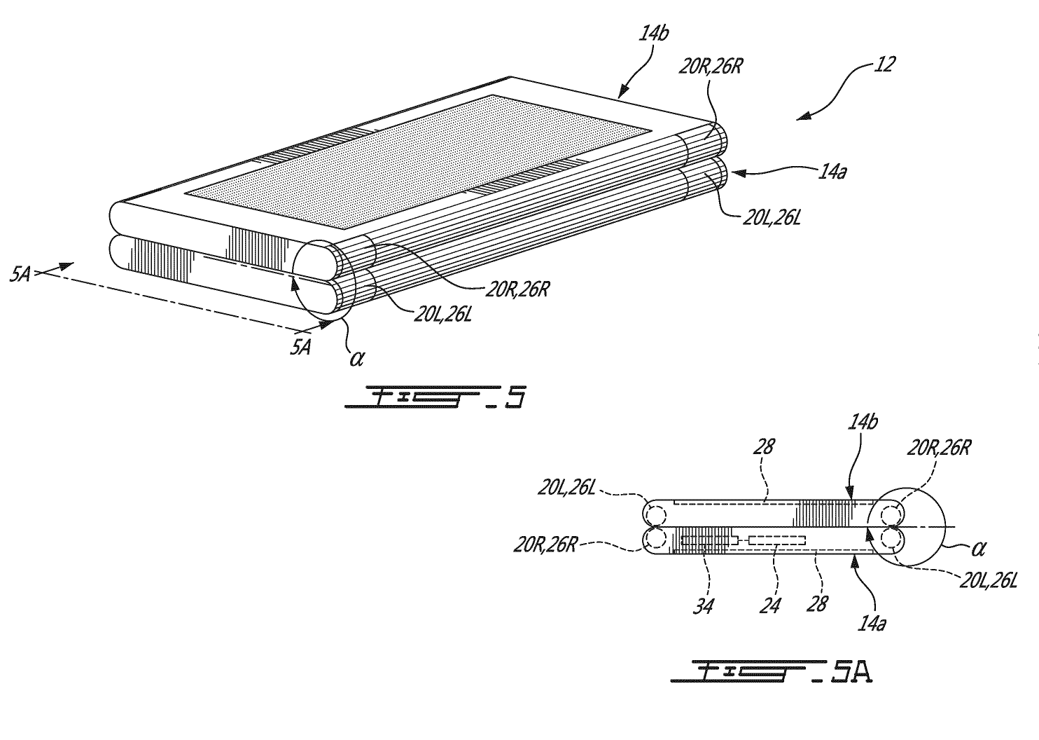

Referring now to FIGS. 5 and 5A, the given range of relative face-to-face pivot angles α is between 345° and 360°. In this case, the modular electronic devices 14a and 14b can be said to be in a back-to-back configuration wherein the back face 32 of the modular electronic device 14a faces the back face 32 of the modular electronic device 14b. In other words, the modular electronic devices 14a and 14b are placed on top of one another, so that the back face 32 of the modular electronic device 14a abuts on the back face 32 of the modular electronic device 14b.

Accordingly, when the processor 24 determines that the relative face-to-face pivot angle α is approximately 360°, the processor 24 selects a primary display function for the touch screen 28 of one of the modular electronic devices 14a and 14b. For instance, in some embodiments, the one of the modular electronic devices 14a, 14b, e.g., the modular electronic device 14a, can function as a primary display for viewing content.

In this specific embodiment, it will be understood that the relative face-to-face pivot angle α can be received from any one of the pivot sensors 26L and 26R of both the modular electronic devices 14a and 14b.

The processor 24 can receive a measurement of an orientation of the modular electronic device 14 indicating that the touch screen 28 of the modular electronic device 14a faces upwards and select the primary display function for the modular electronic device 14a. Such a measurement can be received from the gyroscope sensor 34 located inside the housing 16 of the modular electronic device 14a.

In alternate embodiments, the processor 24 can be configured to select the primary display function for which one of the modular electronic devices 14a and 14b based on one or more user inputs. Other embodiments of the gyroscope sensor 34 can also be used.

In some other embodiments, the touch screen of one of the modular electronic devices 14a, 14b, e.g., the modular electronic device 14a, can function as a primary display for viewing content while touch screen 28 of the other one of the modular electronic device 14b, e.g., the modular electronic device 14b can function as an auxiliary display. In these embodiments, the auxiliary display can be used for displaying notifications visible at a glance.

In these latter embodiments, the processor 24 can determine which of the touch screens 28 will function as the primary display or the auxiliary display based on a measurement of an orientation of either or both of the modular electronic devices 14a, 14b received from the gyroscope sensor 34.

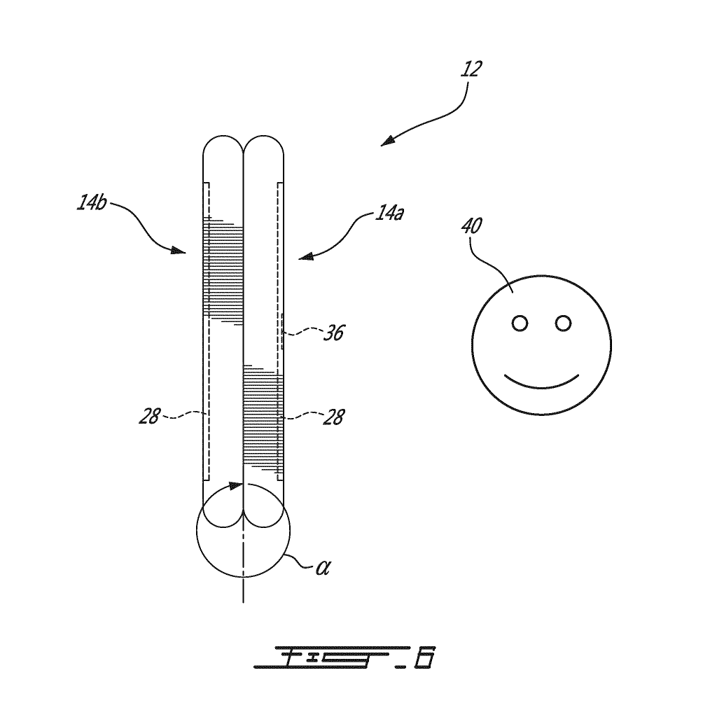

Alternatively, as illustrated in FIG. 6, the processor 24 can received an indication that the touch screen 28 of the modular electronic device 14a faces a user and select the primary display function for the modular electronic device 14a. The indication can be received from a camera 36 provided at the front face 30 of the modular electronic device 14a, as shown in FIG. 4. In these embodiments, the indication is based on visual recognition, e.g., facial recognition. In this embodiment, the gyroscope sensor 34 is provided in the form of a camera 36 provided at the front face 30 of the modular electronic device 14a, wherein the measurement of the orientation is based on facial recognition of a face 40 of a user.

It is understood that when the modular electronic device 14a functions as a primary display, the modular electronic device 14b can simply be put into a sleep mode. Alternatively, while the modular electronic device 14a functions as a primary display, the touch screen 28 of the modular electronic device 14b can be turned off, for power consumption purposes.

In some cases, there can be more than the two modular electronic devices 14a and 14b coupled to one another. For example, more than two modular electronic devices can be coupled to one another, side-by-side, stacked or in any other suitable configuration. In these cases, the processor 24 can be configured to receive more than one relative pivot angles between corresponding pairs of modular electronic devices and to select a software function accordingly.

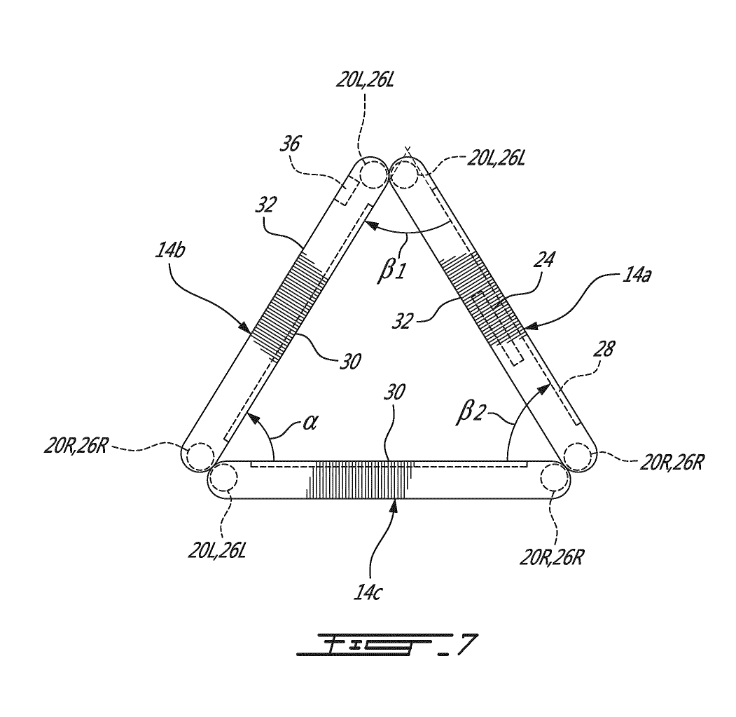

For instance, FIG. 7 shows an embodiment where three modular electronic devices 14a, 14b and 14c are arranged in a complex configuration wherein the two lateral edges of any of the modular electronic devices are coupled with a lateral edge of a different modular electronic device. In this embodiment, the modular electronic devices can be said to be in a camera stand configuration. More specifically, in this embodiment, the magnetic couplers 20L of the modular electronic device 14a are engaged with the magnetic couplers 20L of the modular electronic device 14b to form a first relative back-to-face pivot angle β1. Still in this embodiment, the magnetic couplers 20R of the modular electronic device 14b are engaged with the magnetic couplers 20L of the modular electronic device 14c to form a first relative face-to-face pivot angle α. Further, the magnetic couplers 20R of the modular electronic device 14c are engaged with the magnetic couplers 20R of the modular electronic device 14a to form a second relative back-to-face pivot angle β2.

In this example, the processor 24 can be configured to receive the first and second relative back-to-face pivot angles β1 and β2 and the relative face-to-face pivot angle α from respective ones of the pivot angle sensors 26R and 26L. Once received, the processor 24 is configured to select a software function for the modular electronic device 14a and to transmit the selected software function to the modular electronic devices 14b and 14c. For instance, in this embodiment, it is determined that the second relative back-to-face pivot angle β 2 is below 90°, or alternatively when the relative pivot angle between the touch screen 28 of the modular electronic device 14a and the back face 32 of the modular electronic device 14b exceeds 270°, the processor 24 is configured to activate functions so as to provide a camera stand. For instance, the processor 24 selects a display function for the modular electronic device 14a to display images captured by the camera, a camera function for the modular electronic device 14b using camera 36 and a power supply function and/or a data storage function for the modular electronic device 14c. For instance, the modular electronic device 14c can provide power supply or data storage to either or both of the modular electronic devices 14a and 14b during use.

The modular electronic devices 14a and 14b can establish a communication channel (wireless or USB through connectors 20L and 20R) to allow camera data to be transmitted from the modular electronic device 14b to the modular electronic device 14a, for display on the touch screen 28 of the modular electronic device 14a. Similarly, a communication channel can be established between the modular electronic device 14c and one or both of the modular electronic devices 14a and 14b to allow camera data to be transmitted to the modular electronic device 14c for storage on a memory thereof.

In some cases, functionality can be redundantly available at multiple modular electronic devices. For example, a display screen, a camera, a memory etc. can be available at multiple modular electronic devices. As can be understood, the appropriate one of the modular electronic device of the modular system for a given functionality can be selected based on the relative pivot angle α or β between the modular electronic devices, notwithstanding how they are coupled to one another.

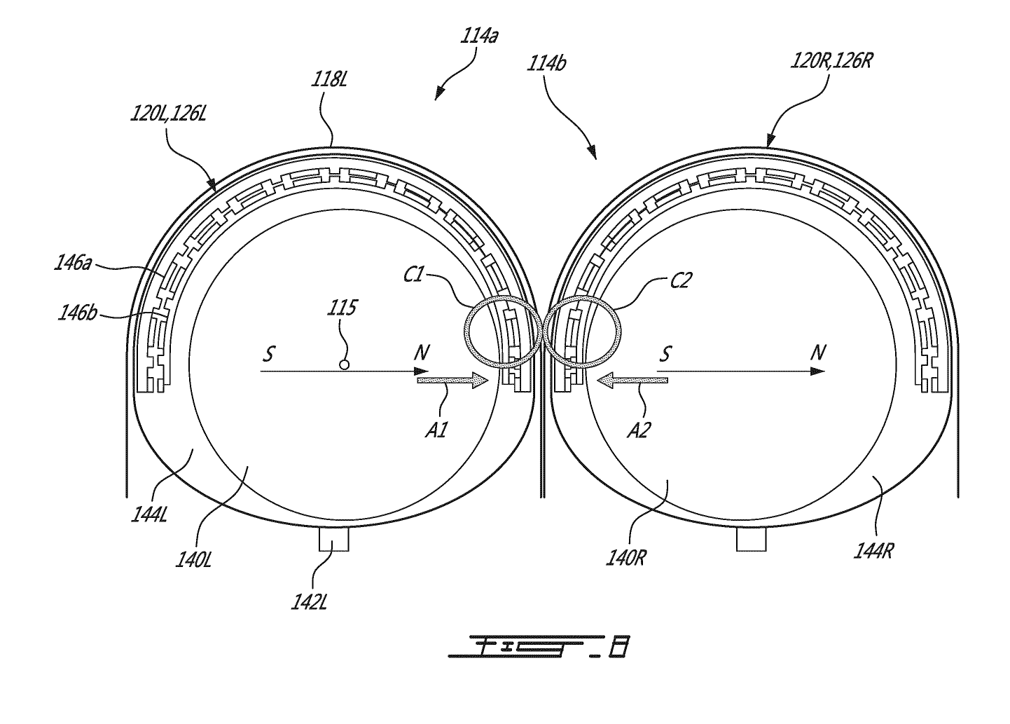

As mentioned above, the relative pivot angle between two modular electronic devices can be measured by way of one of more pivot angle sensors integrated in corresponding one of the magnetic couplers. An example of such pivot angle sensor is shown in FIGS. 8-10 and further described, along with other variants of the pivot angle sensor, in PCT Patent Application No. PCT/CA2016/051347, the contents of which are incorporated by reference herein.

FIG. 8 shows a cross-sectional view of an example of modular electronic devices 114a and 114b coupled to one another using magnetic couplers 120L and 120R. In this example, the magnetic couplers 120L and 120R include a respective one of a pivot angle sensor 126L and 126R.

More specifically, the magnetic coupler 120L is disposed proximate a lateral edge 118L of the modular electronic device 114a that contacts the other modular electronic device 114b (e.g., at a corner). The magnetic coupler 120L has magnet 140L which is biased to a resting position, e.g., by a ferrous stop 142L. The magnet 140L has a north-south orientation as shown. The magnet 140L is shaped to be rotatable (e.g., about an axis 115 perpendicular to the page). So, the magnet 140L can be cylindrical, spherical, etc. The magnet 140L can be made from rare earth materials, such as Neodymium-Iron-Boron (NdFeB), Samarium-cobalt, as are generally available. The magnet 140L can also be made from iron, nickel or other suitable alloys.

When the modular electronic device 114a is brought into connection with the other modular electronic device 114b having its own suitably positioned magnet(s) 114R, the magnet 140L moves to a particular position within the cavity 144L based on the relative pivot angle between the modular electronic devices 114a and 114b. The magnet 140L also rotates to meet the magnet(s) 140R in the other modular electronic device 114b.

As depicted, the pivot angle sensor 126L is integrated to the magnetic coupler 120L in a way that can allow to detect the position of a movable magnet 140L. The position of the magnet 140L is a function of the relative pivot angle between the modular electronic devices 114a and 114b. As such, the relative pivot angle can be determined from the detected position of the magnet 140L.

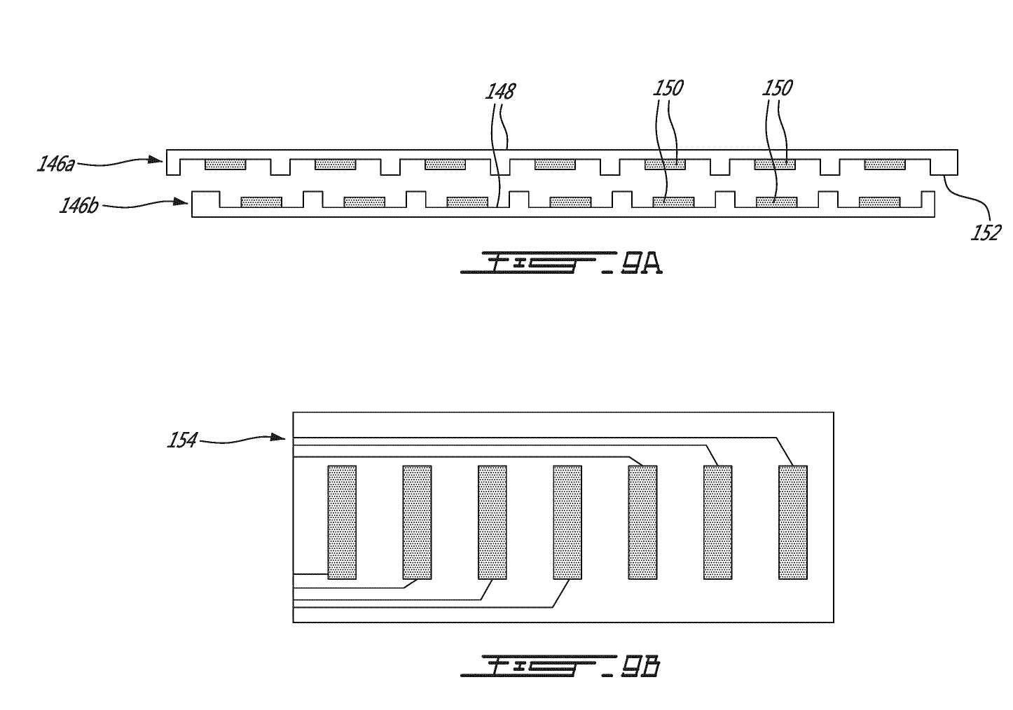

The pivot angle sensor 126L includes outside and inside sensor strips 146a and 146b to detect the particular position of the magnet 140L within the cavity 144L. The strips 146a and 146b are best seen in FIG. 9A. Each sensor strip 146a,146b is formed of a flexible printed circuit board (PCB) 148. Each strip 146a,146b contains a plurality of electrical contacts 150 disposed slightly below the surface 152 of the PCB 148. In this way, when the two strips 146a and 146b are placed next to one another, electrical contacts on the strips 146a and 146b do not connect with one another.

A conductive trace 154 such as the one shown in FIG. 9B is provided to each of the electrical contacts 150. Using a flexible PCB 148 allows the sensor strips 146a and 146b to be curved as shown in FIG. 8. The outside sensor strip 146a is sized to be larger than the inside sensor strip 146b so that the electrical contacts 150 are aligned when the strips 146a and 146b are curved. Although two sensor strips 146a and 146b are shown, the interior and exterior sensor strips can be formed as a single PCB (e.g., in multiple layers). The pivot angle sensor 126L can be formed by inserting the strips 146a and 146b between the magnet 140L of the magnetic coupler 120L and an inside surface of the lateral edge 118L.

When the modular electronic devices 114a and 114b are coupled to one another, the two magnets 140L and 140R move in their respective cavities 144L and 144R towards each other. In this position, the magnet 140L impinges against the sensor strips 146a and 146b to cause a pair of electrical contacts 150 to be pressed together (see circle C1 and C2). This completes an electrical path by way of the traces 154 (see FIG. 9B), which can be detected. So, each pair of electrical contacts 150 is capable of generating an open/closed signal. The force vector created by each magnet is shown as arrows A1 and A2.

Suitable electronics can be provided to convert the open/closed state of each pair of electrical contacts 150 into a binary sequence, e.g., 0 0 0 0 0 1 0 0 0 0 where 1 indicates a closed state and 0 indicates an open state. This sequence can be processed using logic programmed at one or both of the modular electronic devices 114a and 114b to determine the relative pivot angle between the modular electronic devices 114a and 114b. More than one electrical contact (e.g., adjacent contacts) can be closed for a given magnet position. In other embodiments, to facilitate signal connection, the sensor strips could be inserted in between the magnet and a signal carrying flexible cable.

In a force-sensor variant, the pivot angle sensor can be modified to use an array of piezo-resistive force sensors instead of the sensor strips. Example of a possible force sensor is model FLX-A101-A marketed by Tekscan or similar. The magnets exert a force of approximately 1N-5N on the sensor. Each force sensor outputs a value indicative of the amount of force sensed. The forces sensed by the array can be processed to determine the relative pivot angle between the modular electronic devices. The force sensor array can produce a sequence of measurements. The force vector of the magnet (and hence the relative pivot angle) can be interpolated from the sequence of measurements.

In a Hall-effect sensor variant, the pivot angle sensor can also be modified to use a Hall-effect sensor instead of the sensor strips. The Hall-effect sensor produces an output signal that indicates the orientation of the magnet when two modular electronic devices are coupled. Note that the magnet can rotate, but does not need to otherwise move. The output of the Hall-effect sensor reflects the strength and direction of the magnetic field around it. The strength/direction can vary according to the relative orientation of two modular electronic devices.

As can be understood, the examples described above and illustrated are intended to be exemplary only. In some other modular systems, there can be more than two modular electronic devices coupled to one another. For instance, there can be 3 (as shown in FIG. 7), 4, 5 or more modular electronic devices coupled to one another. In these cases, the processor is configured to receive, from corresponding pivot angle sensors, a measurement of a relative pivot angle between each pair of modular electronic devices which are coupled to one another. In some embodiments, either or both of the lateral edges of the modular electronic device have only one magnetic coupler. In some other embodiments, either or both of the lateral edges of the modular electronic device can have more than two magnetic couplers. The magnetic couplers and/or pivot angle sensors need not be provided at the corners of the modular electronic device. For instance, in some other embodiments, the magnetic couplers and/or pivot angle sensors are provided in the middle of the corresponding lateral edge. The pivot angle sensors need not be integrated in corresponding magnetic couplers. Indeed, the pivot angle sensors can be separate from the magnetic couplers in some embodiments. Additionally, additional sensor data can also be received from other sensors (e.g., gyroscope sensor(s), camera(s)) integrated to any of the modular electronic device in order to select the software function and, more specifically, to disambiguate between which software function will be selected for each modular electronic device. As understood from plain reading of the description above, each modular electronic device can be configured to measure the relative pivot angle. Alternatively, one of the modular electronic devices of the modular system can measure the relative pivot angle and request functionality from other devices (e.g., USB slaves). As mentioned above, it is preferred that the touch screen of one of the modular electronic devices which faces a user be used as a display. Similarly, the relative orientation between the modular electronic devices and the user can be used to select other functionality such as which of the modular electronic device provides a microphone function. Also, whether any I/O components such as displays, cameras and speakers are included in any of the modular electronic device, the processor 24 selects a software function different than a display function when a display of a corresponding modular electronic device is not visible to a user. Moreover, the processor 24 selects a software function based also on a relative resource availability of the modular electronic devices (e.g., battery level, data storage availability, bandwidth availability, etc.). In some embodiments, a processor of one of the devices determines what functionality is desired, enumerates available functionality from interconnected modular electronic devices, and establishes a priority list among the devices for obtaining particular functionality based on the value of any one of the relative pivot angles, and other factors. Thereafter, the processor requests functionality from other modular electronic devices. If the request is rejected, then the controller requests functionality from another device, according to the established priority list. The scope is indicated by the appended claims.

What is claimed is:

1. A modular electronic device configured for coupling with at least one other modular electronic device of a modular electronic device system wherein the modular electronic devices of the modular electronic device system each have a housing with lateral edges having at least one magnetic coupler and wherein any two of the modular electronic devices are coupleable to one another by engaging corresponding magnetic couplers of the two modular electronic devices with one another, the coupled modular electronic devices being pivotable relative to one another, the modular electronic device comprising a processor configured for receiving a measurement of the relative pivot angle between the modular electronic device and another modular electronic device coupled thereto, and selecting a software function based on the measurement of the relative pivot angle.

2. The modular electronic device of claim 1 wherein the measurement of the relative pivot angle is received from a pivot angle sensor integrated in the housing of the modular electronic device.

3. The modular electronic device of claim 2 wherein the pivot angle sensor is integrated to at least one magnetic coupler of the modular electronic device.

4. The modular electronic device of claim 1 wherein said processor is configured to receive a measurement of an orientation of at least one of the modular electronic devices from a gyroscope sensor.

5. The modular electronic device of claim 4 wherein the gyroscope sensor is integrated to the housing of the at least one of the modular electronic devices.

6. The modular electronic device of claim 1 wherein said processor is configured to receive an indication of an orientation of at least one of the modular electronic devices from a camera.

7. The modular electronic device of claim 6 wherein the camera is integrated to the at least one of the modular electronic devices.

8. A method of operating a modular electronic device system comprising a modular electronic device coupled to at least one other modular electronic device, the modular electronic devices each having a housing with lateral edges having at least one magnetic coupler, any two of the modular electronic devices being coupleable to one another by engaging corresponding magnetic couplers of the two modular electronic devices with one another, the coupled modular electronic devices being pivotable relative to one another, the method comprising: receiving, using a processor included in the housing of the modular electronic device, a measurement of the relative pivot angle between the modular electronic device and the other modular electronic device coupled thereto; and selecting a software function based on the measurement of the relative pivot angle.

9. The method of claim 8 wherein said selecting is based on a determination of which of the magnetic couplers of the modular electronic device is engaged to which of the magnetic couplers of the other modular electronic device.

10. The method of claim 8 wherein the modular electronic device and the other modular electronic device each have a front face and an opposite back face between the lateral edges and a touch screen at the front face, said selecting the software function being further based on determining that the measurement of the relative pivot angle is within a given range of relative pivot angles between the front face of the modular electronic device and the front face of the other modular electronic device.

11. The method of claim 10 wherein the given range of relative pivot angles is between 135° and 225°, said processor selecting a software function including selecting a display function for the touch screen of the modular electronic device and a display function for the touch screen of the other modular electronic device, the display functions being stitched to one another.

12. The method of claim 10 wherein the given range of relative pivot angles is between 0° and 15°, said processor selecting a software function including at least one of locking the touch screens of the modular electronic devices and putting the modular electronic devices into a sleep mode.

13. The method of claim 10 wherein the given range of relative pivot angles is between 75° and 135°, said processor selecting a software function including selecting an on-screen keyboard function for the touch screen of the modular electronic device and selecting a display function for the touch screen of the other modular electronic device.

14. The method of claim 13 wherein at least one of said selecting an on-screen keyboard function and selecting a display function are based on a measurement of an orientation of at least one of the modular electronic devices.

15. The method of claim 10 wherein the given range of relative pivot angles is between 345° and 360°, said processor selecting a software function including selecting a primary display function for the touch screen of one of the modular electronic devices.

16. The method of claim 15 wherein said selecting a primary display function for the touch screen of one of the modular electronic devices is based on a measurement of an orientation of at least one of the modular electronic devices.

17. The method of claim 15 wherein said selecting a software function includes selecting an auxiliary display function for the touch screen of the other one of the modular electronic devices.

18. The method of claim 10 wherein the modular electronic device system includes the modular electronic device, the other modular electronic device and a third modular electronic device coupled to one another, said receiving comprising receiving a measurement of a second relative pivot angle between the other modular electronic device and the third modular electronic device, said selecting the software function being further based on the measurement of the second relative pivot angle.

19. The method of claim 18 wherein each of the modular electronic devices having one of its lateral edges coupled to one of the lateral edges of a different one of the modular electronic devices, said receiving comprising receiving a measurement of a third relative pivot angle between the modular electronic device and the third modular electronic device, said selecting the software function being further based on the measurement of the third relative pivot angle.

20. The method of claim 19, wherein the modular electronic device has a display screen on a face thereof and the other modular electronic device has a camera on a face thereof, said selecting the software function comprising selecting a display function for the modular electronic device and selecting a camera function for the other modular electronic device when the relative pivot angle between the face of the modular electronic device and the face of the other modular electronic device exceeds 270°.

21. The method of claim 8 wherein said selecting a software function includes transmitting the selected software function to the at least one other modular electronic device of the modular electronic device system.
